(19) United States
(12) Patent Application Publication
(10) Pub. No.: US 2026/0184935 A1
(43) Pub. Date: Jul. 2, 2026

(54) KIT FOR FORMING ANTI-CORROSIVE COATING COMPOSITION, ANTI-CORROSIVE COATING COMPOSITION AND METHOD FOR PREPARING THE SAME

(71) Applicant: SHINY CHEMICAL INDUSTRIAL CO., LTD., Kaohsiung City (TW)

(72) Inventors: Sheng-Wei LIN, Kaohsiung City (TW); Hsuan-Shen CHAO, Kaohsiung City (TW); Chi-Fa SUN, Kaohsiung City (TW)

(73) Assignee: SHINY CHEMICAL INDUSTRIAL CO., LTD., Kaohsiung City (TW)

(21) Appl. No.: 19/188,588

(22) Filed: Apr. 24, 2025

(30) Foreign Application Priority Data
Jan. 2, 2025 (TW) 114100136

(51) Int. Cl. C09D 5/08; C08K 3/36; C08K 5/5419; C09D 7/20; C09D 7/61; C09D 7/63; C09D 7/80; C09D 163/00

(52) U.S. Cl. CPC C09D 5/08; C08K 3/36; C08K 5/5419; C09D 7/20; C09D 7/61; C09D 7/63; C09D 7/80; C09D 163/00; C08K 2201/003

(57) ABSTRACT

A kit for forming an anti-corrosive coating composition includes a first component and a second component. The first component includes, based on a total weight of the first component, 5 wt % to 40 wt % of dialkoxy-substituted silane, 5 wt % to 20 wt % of alkyltrialkoxysilane, 35 wt % to 50 wt % of (epoxyalkoxy)alkyltrialkoxysilane and a balance of tetraalkoxysilane. The second component includes an acidic pH modifier and a solvent. A weight ratio of the second component to the first component ranges from 1.3:1 to 1.5:1. The anti-corrosive coating composition is prepared by mixing the first component with the second component of the kit. A method for preparing an anti-corrosive coating composition includes gradually adding the first component into the second component. The first component includes dialkoxy-substituted silane, alkyltrialkoxysilane, (epoxyalkoxy)alkyltrialkoxysilane, and a balance of tetraalkoxysilane. The second component includes an acidic pH modifier and a solvent.

### CROSS-REFERENCE TO RELATED APPLICATION

This application claims priority to Taiwanese Invention patent application No. 114100136, filed on Jan. 2, 2025, the entire disclosure of which is incorporated by reference herein.

### FIELD

The disclosure relates to a kit for forming an anti-corrosive coating composition, and the anti-corrosive coating composition prepared by the kit. The disclosure also relates to a method for preparing the anti-corrosive coating composition.

### BACKGROUND

In chemical factories, storage tanks are frequently used to accommodate a variety of raw materials, and pipes are used to allow the storage tanks to be in fluid communication with one another. The storage tanks and the pipes are usually assembled using various connection elements (e.g., screws, bolts, spacers, etc.). Since the fluid transported through the pipes may be an organic solvent, which may corrode metal-based connection elements, anti-corrosive treatment is usually required to be performed on the metal-based connection elements. A practical solution is to coat an anti-corrosive coating composition on surfaces of the metal-based connection elements, so as to form an anti-corrosive protection layer thereon. However, conventional anti-corrosive coating compositions may have certain problems, e.g., poor solvent resistance, poor adhesion, etc. In addition, the conventional anti-corrosive coating compositions usually include environmentally unfriendly solvents. Thus, a new anti-corrosive coating composition that can resolve the aforesaid problems is required.

### SUMMARY

Therefore, an object of the disclosure is to provide a kit for forming an anti-corrosive coating composition, an anti-corrosive coating composition, and a method for preparing an anti-corrosive coating composition that can alleviate at least one of the drawbacks of the prior art.

According to a first aspect of the disclosure, a kit for forming an anti-corrosive coating composition includes a first component which includes, based on a total weight of the first component, 5 wt % to 40 wt % of dialkoxy-substituted silane, 5 wt % to 20 wt % of alkyltrialkoxysilane, 35 wt % to 50 wt % of (epoxyalkoxy)alkyltrialkoxysilane and a balance of tetraalkoxysilane, and a second component which includes an acidic pH modifier and a solvent. A weight ratio of the second component to the first component ranges from 1.3:1 to 1.5:1.

According to a second aspect of the disclosure, an anti-corrosive coating composition is prepared by mixing the aforesaid first component with the aforesaid second component of the kit.

According to a third aspect of the disclosure, a method for preparing an anti-corrosive coating composition includes gradually adding a first component into a second component. The first component includes 5 wt % to 40 wt % of dialkoxy-substituted silane, 5 wt % to 20 wt % of alkyltrialkoxysilane, 35 wt % to 50 wt % of (epoxyalkoxy)alkyltrialkoxysilane and a balance of tetraalkoxysilane, based on a total weight of the first component. The second component includes an acidic pH modifier and a solvent. A weight ratio of the second component to the first component ranges from 1.3:1 to 1.5:1.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

An embodiment of a kit for an anti-corrosive coating composition according to the present disclosure includes a first component and a second component. The first component includes, based on a total weight of the first component, 5 wt % to 40 wt % of dialkoxy-substituted silane, 5 wt % to 20 wt % of alkyltrialkoxysilane, 35 wt % to 50 wt % of (epoxyalkoxy)alkyltrialkoxysilane, and tetraalkoxysilane. The second component includes an acidic pH modifier, and a solvent. A weight ratio of the second component to the first component ranges from 1.3:1 to 1.5:1.

The dialkoxy-substituted silane may be present in an amount of 10 wt %, 15 wt %, 20 wt %, 25 wt %, 30 wt %, or 35 wt %, based on the total weight of the first component. In some embodiments, the dialkoxy-substituted silane is present in the amount ranging from 20 wt % to 40 wt %. The dialkoxy-substituted silane may be dialkoxydialkylsilane, e.g., dialkyldimethoxysilane or dialkyldiethoxysilane. In some embodiments, the dialkyldimethoxysilane is dimethoxydimethylsilane.

The alkyltrialkoxysilane may be present in an amount of 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, or 19 wt %, based on the weight of the first component. The alkyltrialkoxysilane may be alkyltrimethoxysilane or alkyltriethoxysilane. In some embodiments, the alkyltrialkoxysilane is methyltrimethoxysilane.

The (epoxyalkoxy)alkyltrialkoxysilane may be present in an amount of 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, or 49 wt %, based on the total weight of the first component. In some embodiments, the (epoxyalkoxy)alkyltrialkoxysilane is present in the amount equal to or greater than 40 wt %. The (epoxyalkoxy)alkyltrialkoxysilane may be (epoxyalkoxy)alkyltrimethoxysilane or (epoxyalkoxy)alkyltriethoxysilane. In some embodiments, the (epoxyalkoxy)alkyltrialkoxysilane is [3-(2,3-epoxypropoxy)-propyl]-trimethoxysilane.

The tetraalkoxysilane may be present in an amount of 10 wt %, 15 wt %, 20 wt %, 25 wt %, 30 wt %, or 35 wt %, based on the total weight of the first component. In some embodiments, the tetraalkoxysilane is present in the amount equal to or greater than 20 wt %. The tetraalkoxysilane may be tetramethoxysilane or tetraethoxysilane. In some embodiments, the tetraalkoxysilane is tetraethoxysilane.

In certain embodiments, the first component is free of a solvent. In some embodiments, the first component is free of water.

The acidic pH modifier is used to provide an acidic environment for the second component, so as to allow ingredients in the first component to dissociate when the first component is added into the second component. In some embodiments, the acidic environment is referred to as an environment having a pH value smaller than 7.0, e.g., 1.0, 1.5, 2.0, 2.5, 3.0, 3.5, 4.0, 4.5, 5.0, 5.5, 6.0, or 6.5. The acidic pH modifier may be a weak acid (e.g., acetic acid or citric acid) or a strong acid (e.g., hydrochloric acid (HCl), hydrofluoric acid (HF), or sulfuric acid (H₂SO₄)). In some embodiments, the acidic pH modifier is the strong acid (e.g., HCl). There is no limitation on a concentration and an amount of the acidic pH modifier as long as the second component provides the acidic environment for the first component.

The solvent may include water, alcohol or a combination thereof. The alcohol may have a formula of R—OH where R is a hydrocarbyl group, e.g., alkyl group. Examples of the alcohol may include, ethanol, n-propanol, isopropyl alcohol, and glycerin. In some embodiments, the solvent is water, and is free of an organic solvent, e.g., the alcohol as mentioned above, ethers, esters, ketones, etc.

In some embodiment, the kit is free of an organic solvent. When the solvent is water and the first component is free of the solvent, an anti-corrosive coating composition made from the kit of this disclosure would not pollute the environment. In addition, since water is easily accessible without requiring complicated synthetic or manufacturing steps, the anti-corrosive coating composition according the present disclosure has energy-saving and carbon-reducing characteristics compared to conventional anti-corrosive coating compositions.

In some embodiments, the second component further includes an oxide. The oxide may include silicon dioxide (SiO₂), titanium dioxide (TiO₂), zirconium dioxide (ZrO₂), or combinations thereof. In certain embodiments, the oxide is silicon dioxide (SiO₂). In some embodiments, based on a total weight of the second component, the oxide is in an amount ranging from 15 wt % to 25 wt %, e.g., 16 wt %, 17 wt %, 18 wt %, 19 wt %, 21 wt %, 22 wt %, 23 wt %, or 24 wt %. In some embodiments, the oxide has a nanoparticle size, which may range from 5 nm to 60 nm, e.g., 10 nm, 20 nm, 30 nm, 40 nm, or 50 nm. Specifically, oxygen atoms in the oxide (e.g., SiO₂) may form attractive force with hydroxyl groups that are formed by hydrolysis of alkoxy groups in the first component, which facilitates dispersion of the oxide (e.g., SiO₂) in the anti-corrosive coating composition.

An embodiment of the anti-corrosive coating composition according to the present disclosure is prepared by the aforesaid kit.

An embodiment of a method for preparing the anti-corrosive coating composition according to the present disclosure includes gradually adding the first component into the second component, and the weight ratio of the second component to the first component ranges from 1.3:1 to 1.5:1. In some embodiments, the first component is added dropwise into the second component. In some embodiments, the first component is added into the second component within a time period ranging from 80 minutes to 100 minutes and with an adding frequency of 1 or 2 times per minute. The anti-corrosive coating composition thus obtained may exhibit superior polarity.

Specifically, when the first component is gradually added into the second component, the alkoxy groups of each of the alkoxysilane in the first component may be hydrolyzed to the hydroxyl groups, and the hydrolyzed alkoxysilane may be well dispersed in the second component. The first component and the second component are mixed to form the anti-corrosive coating composition in a hydrogel form.

In some embodiments, the weight ratio of the second component to the first component may be 1.35:1, 1.4:1, or 1.45:1. If the weight ratio is smaller than 1.3:1, a protection layer formed from the anti-corrosive coating composition may have poor hardness. If the weight ratio is larger than 1.5:1, the protection layer may be brittle.

In some embodiments, during addition of the first component into the second component, a mixture of the first component and the second component may be heated at a temperature ranging from 70° C. to 90° C. (e.g., 75° C., 80° C., or 85° C.) with a stirring rate ranging from 250 rpm to 350 rpm (e.g., 275 rpm, 300 rpm, or 325 rpm). In certain embodiments, after the first component is completely added into the second component, the mixture is still kept at the temperature ranging from 70° C. to 90° C. with the stirring rate ranging from 250 rpm to 350 rpm for a time period ranging from 4 hours to 6 hours, so that the reaction is relatively complete.

The anti-corrosive coating composition may then be applied onto an object and then heated in an oven to remove the solvent (e.g., water), so that the anti-corrosive coating composition may be polymerized to form the protection layer. The object may be a metal-based connection element (e.g., screw, bolt, spacer, etc.). By forming the protection layer, the metal-based connection element may have an anti-corrosive capability.

The dialkoxy-substituted silane may improve toughness and ductility of the protection layer. The alkyltrialkoxysilane and the (epoxyalkoxy)alkyltrialkoxysilane may cooperatively improve solvent resistance of the protection layer and binding strength (e.g., adhesion) between the object and the protection layer. The tetraalkoxysilane may improve compactness of the protection layer. In some embodiments, in order to have desired properties of the toughness, the solvent resistance, the binding strength and the compactness, the dialkoxy-substituted silane, the alkyltrialkoxysilane, the (epoxyalkoxy)alkyltrialkoxysilane, and the tetraalkoxysilane are present in the aforesaid amounts.

The oxide of the second component may provide improved scratching resistance for the protection layer.

The present disclosure will be further described with reference to the following examples. However, it should be understood that the following examples are merely for illustration and should not be considered as limitation of implementing the present disclosure.

### Example 1

24 wt % of dimethoxydimethylsilane silane (CAS No. 1112-39-6, commercially available from Topco Technologies™ Corp., reagent grade (>99%), molecular weight: 120.2), 12 wt % of methyltrimethoxysilane (CAS No. 1185-55-3, commercially available from Topco Technologies™ Corp., reagent grade (>99%), molecular weight: 136.2), 42 wt % of [3-(2,3-epoxypropoxy)-propyl]-trimethoxysilane (CAS No. 2530-83-8, commercially available from Topco Technologies™ Corp., reagent grade (>99%), molecular weight: 236.3), and 22 wt % of tetraethoxysilane (CAS No. 78-10-4, commercially available from Thermo Fisher Scientific™ Inc., reagent grade (>99%), molecular weight: 208.3) were mixed to obtain a first component.

1.5 wt % of 0.2 N hydrochloric acid (commercially available from Honeywell International™ Inc., reagent grade (37 wt %), serving as an acidic pH modifier), 20 wt % of silicon oxide (commercially available from Nissan Chemical Corp.™ Inc., having an average diameter ranging from 10 nm to 15 nm), and 78.5 wt % of water (serving as a solvent) were mixed to obtain a second component with a pH value ranging from 2 to 4.

The second component was heated to and kept at 80° C., and then, the first component was gradually added (i.e., added in a dropwise manner) into the second component with a stirring rate of 300 rpm. The first component was dripped to the second component at a speed of one drop per minute for a time period of 90 minutes. That is to say, if the total weight of the first component to be added was x, then the weight added each time was x/90. A weight ratio of the second component to the first component was 1.5:1. After the first component was completely added into the second component, a mixture thus formed was maintained at 80° C. with the stirring rate of 300 rpm for another 5 hours, so as to obtain an anti-corrosive coating composition.

The anti-corrosive coating composition was applied onto a tinplate with a size of 17 cm×4 cm, so as to form a coating layer with a thickness of 3 μm on the tinplate. Then, the tinplate coated with the coating layer was placed in an oven and heated at 180° C. for 30 minutes, so that the coating layer was dried to form a protection layer, thereby obtaining a sample.

### Adhesion Test

The sample was subjected to an adhesion test in accordance to the procedures set forth in ASTM D3359. The protection layer of the sample was subjected to a series of crosshatch cuts to form a plurality of regions among the crosshatch cuts, followed by observing the peeling/removal of the regions. The adhesion between the protection layer and the tinplate was determined based on the criteria shown in Table 1.

TABLE 1

| | | Percentage of |
|---|---|---|
| | ASTM D3359 | area of protection |
| Grade | Rating | layer that is removed |
| Excellent | 5B | 0% |
| Great | 4B | <5% |
| Good | 3B | 5% to 15% |
| Poor | 2B | 15% to 35% |
| Poor | 1B | 35% to 65% |
| Poor | 0B | >65% |

### Solvent Resistance Test

The sample was subjected to a solvent resistance test in accordance to the procedures set forth in ASTM D4752. In brief, a cotton cloth was folded, and then soaked into methyl ethyl ketone (MEK) to obtain a MEK-containing cotton cloth. Thereafter, a surface of the protection layer of the sample was rubbed with the MEK-containing cotton cloth back and forth for 50 times, followed by observing the change on the surface of the protection layer. The solvent resistance of the protection layer was determined based on the criteria shown in Table 2.

TABLE 2

| | ASTM D4752 | |
|---|---|---|
| Grade | Rating | Result |
| Excellent | 5 | No effect on rubbed surface |
| | | of protection layer |
| Great | 4 | Burnished appearance on rubbed |
| | | surface of protection layer |
| Poor | 3 | Some marring and depression |
| | | of protection layer |
| Poor | 2 | Heavy marring and depression |
| | | of protection layer |
| Poor | 1 | Heavy depression in protection |
| | | layer but no actual penetration |
| | | into tinplate |
| Poor | 0 | Penetration into tinplate |

### Examples 2 to 5

The procedures and conditions for preparing the samples of Examples 2 to 5 were similar to those in Example 1, except that the amounts of the ingredients, and weight ratios of the first component to the second component were varied as shown in Table 3 below.

The samples of Examples 2 to 5 were also subjected to the adhesion test and the solvent resistance test, and the results are presented in Table 3. It should be noted that, in the adhesion test, the sample of Example 3 shows a grade falling between “Good” and “Great”, and thus, the result is presented as “Good/Great” in Table 3.

TABLE 3

| | | Exam- | Exam- | Exam- | Exam- | Exam- |
|---|---|---|---|---|---|---|
| | | ple 1 | ple 2 | ple 3 | ple 4 | ple 5 |
| Component | | (wt %) | (wt %) | (wt %) | (wt %) | (wt %) |
| First | Dimethoxy- | 24 | 7 | 24 | 37 | 24 |
| component | dimethyl- | | | | | |
| | silane | | | | | |
| | Methyltri- | 12 | 12 | 5.5 | 12 | 16 |
| | methoxy- | | | | | |
| | silane | | | | | |
| | [3-(2,3- | 42 | 42 | 48.5 | 42 | 38 |
| | epoxypropoxy)- | | | | | |
| | propyl]- | | | | | |
| | trimethoxy- | | | | | |
| | silane | | | | | |
| | Tetraethoxy- | 22 | 39 | 22 | 9 | 22 |
| | silane | | | | | |
| Second | Water | 78.5 | 78.5 | 79.3 | 78.5 | 78.5 |
| component | HCl | 1.5 | 1.5 | 1.5 | 1.5 | 1.5 |
| | SiO₂ | 20 | 20 | 19.2 | 20 | 20 |
| Weight ratio of second | | 1.5:1 | 1.48:1 | 1.46:1 | 1.32:1 | 1.48:1 |
| component to first component | | | | | | |
| Property | Adhesion | Excellent | Great | Great/Good | Great | Great |
| Evaluation | Test | | | | | |
| | Solvent | Excellent | Excellent | Excellent | Poor | Poor |
| | Resistance | | | | | |
| | Test | | | | | |

### Comparative Examples 1 to 3

The procedures and conditions for preparing the samples of Comparative Examples 1-3 were similar to those in Example 1, except that the ingredients, the amounts of the ingredients, and weight ratios of the first component to the second component were varied are shown in Table 4 below.

TABLE 4

| | | Compar- | Compar- | Compar- |
|---|---|---|---|---|
| | | ative | ative | ative |
| | | Example 1 | Example 2 | Example 3 |
| Component | | (wt %) | (wt %) | (wt %) |
| First | Dimethoxy- | 24 | 24 | 24 |
| component | dimethylsilane | | | |
| | Methyl- | 0 | 12 | 12 |
| | trimethoxysilane | | | |
| | [3-(2,3- | 54 | 42 | 42 |
| | epoxypropoxy)- | | | |
| | propyl]- | | | |
| | trimethoxysilane | | | |
| | Tetraethoxy- | 22 | 22 | 22 |
| | silane | | | |
| Second | Water | 78.5 | 78.5 | 78.5 |
| component | HCl | 1.5 | 1.5 | 1.5 |
| | SiO₂ | 20 | 20 | 20 |
| Weight ratio of second | | 1.25:1 | 1:1 | 1.75:1 |
| component to first component | | | | |
| Property | Adhesion Test | Poor | Excellent | Excellent |
| Evaluation | Solvent | Poor | Excellent | Excellent |
| | Resistance Test | | | |

It is apparent from the results shown in Tables 3 and 4 that the protection layers of Examples 1 to 5 exhibit superior grades ranging from “Great/Good” to “Excellent” in the adhesion test. In contrast, the protection layer of Comparative Example 1, which is free from methyltrimethoxysilane, exhibits “Poor” grade in the adhesion test and the solvent resistance test.

The protection layers of Comparative Examples 2 and 3 are made from the same ingredients as those of Example 1, and exhibit “Excellent” grade in the adhesion test and the solvent resistance test. However, the protection layer of Comparative Example 2 show insufficient hardness due to the low weight ratio of the second component to the first component therein (weight ratio is 1:1). The protection layer of Comparative Example 3, has excessively high hardness and is brittle because the weight ratio of the second component to the first component therein is 1.75:1. That is to say, the protection layers of Comparative Examples 2 and 3 may not satisfy industrial requirements because of their inadequate hardness (i.e., insufficient hardness or excessively high hardness).

Moreover, the protection layer of Example 1 exhibits excellent adhesion property as compared to that of Example 2 (exhibiting “Great” grade), which may be attributed to the increased amount of the dimethoxydimethylsilane (from 7 wt % to 24 wt %).

The protection layers of Example 1 and Example 3 also show improved adhesion property (from “Great/Good” to “Excellent”) due to increase in the amount of the methyltrimethoxysilane from 5.5 wt % to 12 wt %.

In addition, the protection layer of Example 1 shows excellent solvent resistance compared to that of Example 4, which may be attributed to the increased amount of the tetraethoxysilane (from 9 wt % to 22 wt %).

The protection layer of Example 1 also shows excellent solvent resistance compared to that of Example 5, which may be attributed to the increased amount of 3-(2,3-epoxypropoxy)propyltrimethoxysilane (from 38 wt % to 42 wt %).

In summary, by inclusion of the particular ingredients of the first component (i.e., the dialkoxy-substitute silane, the alkyltrialkoxysilane, the (epoxyalkoxy)alkyltrialkoxysilane, and the tetraalkoxysilane), controlling the specific weight ratio of the second component to the first component, and gradually adding the first component into the second component, the protection layer made by the kit of the present disclosure is capable of exhibiting improved adhesion and solvent resistance properties. In addition, since the anti-corrosive coating composition only includes water as a solvent and does not contain any environmentally unfriendly solvent, the anti-corrosive coating composition of the present disclosure is environmentally friendly and has energy-saving and carbon-reducing characteristics greater than those of conventional coating composition. Furthermore, since the anti-corrosive coating composition of the present disclosure can be subjected to heat treatment at 180° C., such coating composition is expected to have good thermal resistance.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A kit for forming an anti-corrosive coating composition, comprising:
a first component which includes, based on a total weight of said first component, 5 wt % to 40 wt % of dialkoxy-substituted silane, 5 wt % to 20 wt % of alkyltrialkoxysilane, 35 wt % to 50 wt % of (epoxyalkoxy)alkyltrialkoxysilane and a balance of tetraalkoxysilane; and
a second component which includes an acidic pH modifier and a solvent,
wherein a weight ratio of said second component to said first component ranges from 1.3:1 to 1.5:1.

2. The kit as claimed in claim 1, wherein, based on the total weight of said first component, the dialkoxy-substituted silane is present in the amount ranging from 20 wt % to 40 wt %.

3. The kit as claimed in claim 2, wherein the dialkoxy-substituted silane is dimethoxydimethylsilane.

4. The kit as claimed in claim 1, wherein, based on the total weight of said first component, the tetraalkoxysilane is present in an amount equal to or greater than 20 wt %.

5. The kit as claimed in claim 1, wherein the tetraalkoxysilane is tetraethoxysilane.

6. The kit as claimed in claim 1, wherein, based on the total weight of said first component, the (epoxyalkoxy)alkyltrialkoxysilane is present in an amount equal to or greater than 40 wt %.

7. The kit as claimed in claim 1, wherein the alkyltriakoxysilane is methyltrimethoxysilane.

8. The kit as claimed in claim 1, wherein the (epoxyalkoxy)alkyltrialkoxysilane is 3-(2,3-epoxypropoxy)propyltrimethoxysilane.

9. The kit as claimed in claim 1, wherein said solvent is water.

10. The kit as claimed in claim 1, wherein said kit is free of an organic solvent.

11. An anti-corrosive coating composition, which is prepared by the kit of claim 1.

12. The anti-corrosive coating composition of claim 11, wherein the first component is gradually added into the second component.

13. A method for preparing an anti-corrosive coating composition, comprising:
gradually adding a first component into a second component, based on a total weight of said first component, said first component including 5 wt % to 40 wt % of dialkoxy-substituted silane, 5 wt % to 20 wt % of alkyltrialkoxysilane, 35 wt % to 50 wt % of (epoxyalkoxy)alkyltrialkoxysilane and a balance of tetraalkoxysilane, said second component including an acidic pH modifier and a solvent, a weight ratio of said second component to said first component ranging from 1.3:1 to 1.5:1.

14. The method as claimed in claim 13, wherein, based on the total weight of said first component, the dialkoxy-substituted silane is present in the amount ranging from 20 wt % to 40 wt %.

15. The method as claimed in claim 14, wherein the dialkoxy-substituted silane is dimethoxydimethylsilane.

16. The method as claimed in claim 13, wherein, based on the total weight of said first component, the tetraalkoxysilane is present in the amount equal to or greater than 20 wt %, and the tetraalkoxysilane is tetraethoxysilane.

17. The method as claimed in claim 13, wherein, based on the total weight of said first component, the (epoxyalkoxy)alkyltrialkoxysilane is present in an amount equal to or greater than 40 wt %.

18. The method as claimed in claim 13, wherein the alkyltriakoxysilane is methyltrimethoxysilane, and the (epoxyalkoxy)alkyltrialkoxysilane is 3-(2,3-epoxypropoxy)propyltrimethoxysilane.

19. The method as claimed in claim 13, wherein said solvent includes water and is free of an organic solvent.

20. The method as claimed in claim 13, wherein the first component is added dropwise into the second component.
